(19) United States
(12) Patent Application Publication
(10) Pub. No.: US 2025/0030270 A1
(43) Pub. Date: Jan. 23, 2025

(54) SYSTEMS AND METHODS OF REMOTE SENSOR POWER HARVESTING

(71) Applicant: T-MOBILE INNOVATIONS LLC, Overland Park, KS (US)

(72) Inventor: Jason Riley HOOD, Black Diamond, WA (US)

(21) Appl. No.: 18/224,019

(22) Filed: Jul. 19, 2023

(51) Int. Cl. H02J 50/00; H02J 7/02; H04W 76/10

(52) U.S. Cl. CPC H02J 50/001; H02J 7/02; H04W 76/10

(57) ABSTRACT

Systems, methods, and devices that facilitate power transfer to a remote sensor using radio frequency (RF) signals described. A remote sensor may harvest energy from signals absorbed by the sensor's antenna. The harvested energy may power the remote sensor and facilitate data transmissions to a base station of a network.

### BACKGROUND

Remote Sensors traditionally rely on dedicated physical connections to the power grid for power. A dedicated physical connection to the power grid commonly requires modification of the physical location surrounding the remote sensor. Said differently, often during installation of a remote sensor a conductive wire is laid or “fished” from the existing electrical infrastructure of a location to the location of the sensor. Commonly, this process involves intentionally damaging the surrounding area (e.g.: cutting a whole in sheet rock; drilling through studs, stone, or concrete; digging a trench, and so forth), running the wire, and patching the damage. This may be time consuming, cost prohibitive, undesirable for another reason, or a combination thereof.

Attempts to use batteries to power remote sensors may have other problematic limitation. For example, batteries traditionally requires a dedicated charging system. As the currently installed battery approaches the end of its charge, the battery must be changed, recharged, or both. Even if a second battery is available, the replacement process commonly requires that the remote sensor is powered off, at least temporarily. As such, traditional processes used to power remote sensors may not be able to provide sufficient flexibility for every situation or location where a remote sensor may be desired.

### BRIEF SUMMARY

A high-level overview of various aspects of the technology described herein is provided as an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter.

For example, a method described herein comprises receiving, by a remote sensor device, a plurality signals broadcast at a plurality of frequencies. Each signal of the plurality of signals can be broadcast at a different frequency of the plurality of frequencies. In some aspects, the plurality of frequencies are in the range of 2.1 GHZ and 86 GHz. Additionally, in some aspects the first signal is selected by filtering the plurality of signals based on a set of software defined radio rules, the filtered set of signals including the first signal and excluding a second signal. The second signal may be used to facilitate bidirectional communication from a network core (e.g., via a RAN) and the user equipment.

Some aspects herein are directed to a radio frequency (RF) powered system for wireless communication. In an aspect, the system includes remote sensor device including at least one antenna communicatively coupled to a rectifier circuit and computer readable memory storing instructions that when executed by the remote sensor device cause the sensor device to perform operations. The operations include receiving, a plurality signals broadcast at a plurality of frequencies, each signal of the plurality of signals broadcast at a different frequency of the plurality of frequencies, and converting a first signal of the plurality of signals to a current.

Some aspects herein are directed to non-transitory storage media storing computer instructions that when executed by at least one processor cause the at least one processor to perform operations. In an aspect, the operations comprise receiving a plurality signals broadcast at a plurality of frequencies. Each signal of the plurality of signals can be broadcast at a different frequency of the plurality of frequencies. In some aspects, the plurality of frequencies are in the range of 2.1 GHZ and 86 GHz. Additionally, in some aspects the first signal is selected by filtering the plurality of signals based on a set of software defined radio rules, the filtered set of signals including the first signal and excluding a second signal. The second signal may be used to facilitate bidirectional communication from a network core (e.g., via a base station) and the remote sensor device.

### BRIEF DESCRIPTION OF THE DRAWINGS

Illustrative embodiments of the present invention are described in detail below with reference to the attached drawing figures, and wherein:

FIGS. 1A and 1B depict illustrative environments suitable for use in remote power harvesting, according to aspects described herein;

FIG. 2 depicts an example sensor device, according to aspects described herein;

FIG. 3 depicts an example method for transferring power harvested from RF signals, according to aspects herein;

FIG. 4 depicts another example method for transferring power harvested from RF signals, according to aspects herein; and

FIG. 5 depicts an exemplary computing device suitable for use in implementing aspects herein.

### DETAILED DESCRIPTION

Sensors and associated devices generally rely on alternating current (AC) or direct current (DC) input to charge or recharge their battery. Traditionally, the recharge process is manually regulated. In other words, a power source (e.g., the electrical grid, electricity scavenged from/generated by an internal combustion engine, or any similar source) provides power while a device is physically or magnetically coupled to the remote sensor device or associated devices. Similarly, external batteries transfer the stored charge to the sensor device until the charge of the external battery is exhausted, the sensor device, or associated device is fully charged, or the external battery is uncoupled from sensor device or associated device. However, traditional systems may not provide an automatic system to harvest radio frequency (RF) spectrum and convert the energy into power to operate the sensor device or charge a battery of the sensor device. Accordingly, embodiments of the systems, processes, devices, and methods described herein may provide for a power harvesting system that converts RF spectrum to a current. The current may be used to power the sensor, stored locally by a sensor device, or a combination thereof.

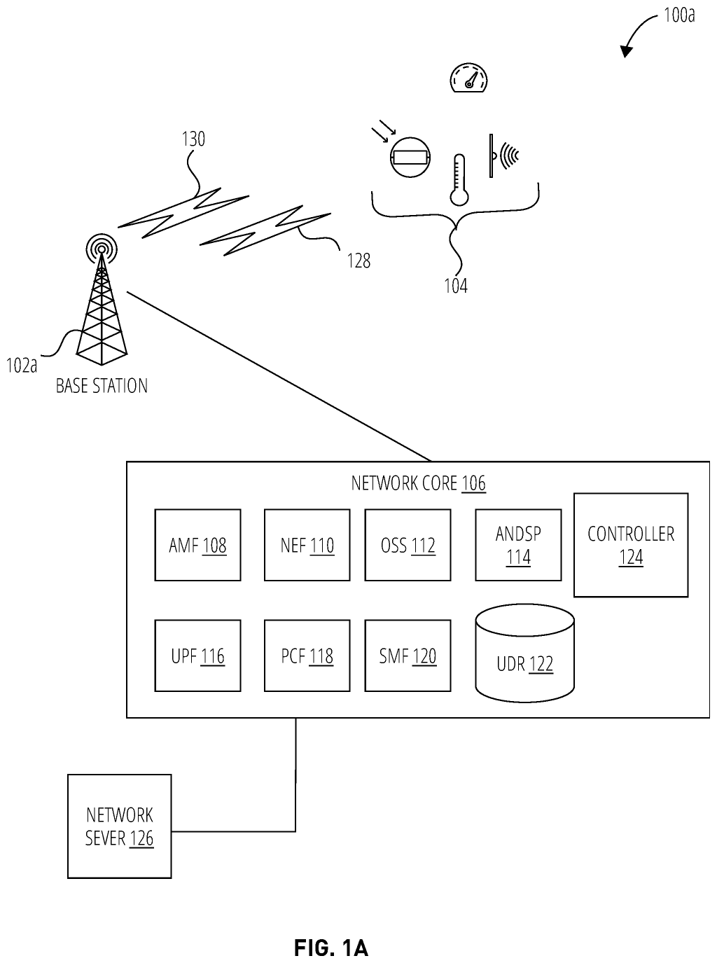

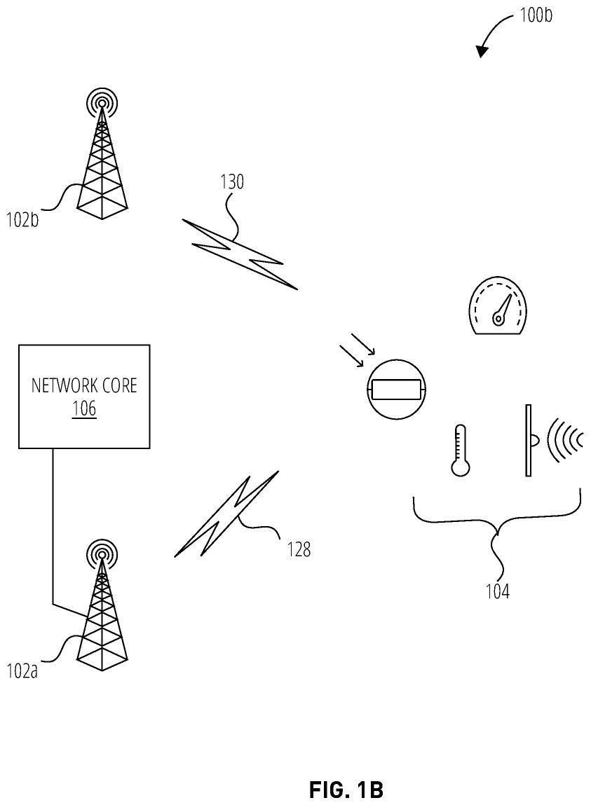

Turning generally to FIGS. 1A and 1B, example network environments 100a and 100b are depicted in accordance with embodiments described herein. Network environments 100a and 100b are but two examples of a suitable network environment and is not intended to suggest any limitation as to the scope of use or functionality of the embodiments disclosed herein. Neither should the network environment be interpreted as having any dependency or requirement relating to any one or combination of components illustrated. Network environments 100a and 100b generally include one or more sensor devices 104, one or more radio access network (RAN) base stations (e.g., base station 102a), and a network core (NOC) (e.g., NOC 106). For example, network environment 100a facilitate the bidirectional communication between sensor device 104 and NOC 106 via base station 102a. To facilitate this bidirectional communication a network environment may use RF signals broadcast by a base station 102a and RF signals broadcast by sensor device 104. The RF signals may be in the range of 2.1 gigahertz (GHz) and 86 GHz.

With specific reference to FIG. 1A network environment 100a includes base station 102a, NOC 106, and one or more sensor devices 104. As mentioned above, network environment 100a facilitates, amongst other things, the bidirectional communication between one or more sensor device 104 and NOC 106 via base station 102a. To facilitate this bidirectional communication network environment 100 may use RF signals broadcast by a base station (e.g., base station 102a) and RF signals broadcast by the one or more sensor device 104. For example, network environment 100a may use RF signals 130 broadcast by a base station 102a and RF signals 128 broadcast by sensor device 104. In an embodiment, RF signals 128 and RF signals 130 are broadcast at the same frequency. In an embodiment, RF signals 128 and RF signals 130 are broadcast at different frequencies. In other words, the uplink (UL) RF and downlink (DL) RF may use the same frequency or may use different frequencies. Additionally, as depicted in FIG. 1A, base station 102a broadcasts RF signals 130 that are received by sensor device 104. RF signals 130 may serve any number of purposes within network environment 100a. For example, RF signals 130 may be used to facilitate unidirectional or bidirectional communications with other sensor devices 104. For another example, RF signals 130 may facilitate network services that sensor device 104 is not currently utilizing. For another example, RF signals 130 may be a signal deliberately broadcast by a RAN as a power harvesting service.

In some embodiments, a base station may selectively communicate with a sensor device 104 using beamforming. For example, the RF signals broadcast by a base station may be adjusted in the x, y, and z planes to steer the RF signals toward, or at least partially toward, a sensor device.

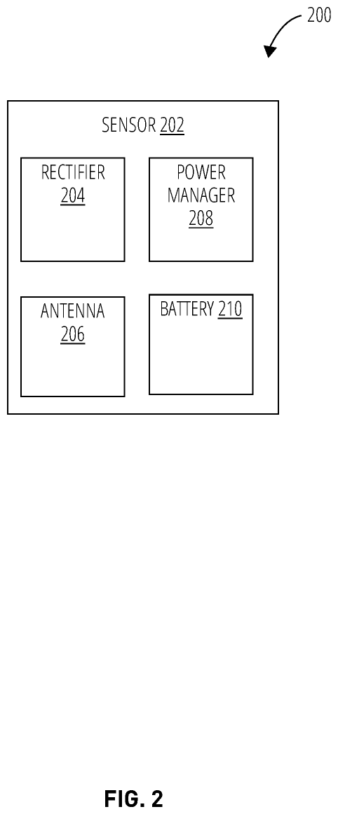

The one or more sensor device 104 can include one or more of the components described in relation to sensor device 200 described in relation to FIG. 2. sensor device 104 generally includes any device that is configured to be installed temporarily, semi-permanently, or permanently, at a location that communicates data to NOC 106, network sever 126, or a combination thereof. For example, sensor device 104 may include one or more access sensors (e.g., door sensors, motion sensors, imaging sensors, thermal sensors) weather data collection sensors (e.g., a wind direction sensor, wind speed sensor, air pressure sensor, air temperature sensor, relative humidity sensor, barometric pressure sensor, radiation sensor, dewpoint sensor, and so forth), road condition sensors (e.g., surface condition sensors, surface temperature sensors, and the like), air quality sensors, water quality sensors, or object detection sensors. In this context, a personal mobile device means any mobile device that has an end-use primary intended purpose other than the collection of data and transmission of that data to a NOC 106, network sever 126, or a combination thereof. For example, personal mobile devices include smartphones, tablets, laptops, and so forth. In contrast, a sensor device is a device that has an end-use primary intended purpose is the collection of the data that is transmitted to NOC 106, network sever 126, or a combination thereof. In some embodiments, the sensor device 104 is a device that an operating system hosted by a remote data center. The remote data center may be incorporated in NOC 106, network server 126, a network server associated with network server 126, or a combination thereof. For example, at least one embodiment of sensor device 104 does not include a locally installed operating system. Rather, the computational burden and power consumption associated with execution of an operating system is offloaded to a remote processor or set of processors communicatively coupled to the sensor device 104 via base station 102a. Advantageously, offloading the operating system of sensor device 104 may facilitate comparatively lower power consumption than a sensor device that includes a locally installed and executed operating system. Further, offloading the operating system of sensor device 104 may facilitate incorporation of comparatively lower localized processing capability than a sensor device that includes a locally installed and executed operating system.

Additionally, or alternatively, the base station broadcasting the RF signals 130 may be different than the base station broadcasting RF signals 128. For example, as depicted in FIG. 1B base station 102b broadcasts RF signals 130. Base station 102b may be similar to base station 102a. Base station 102b may be part of the same communication network (e.g., connected to the same NOC 106 or a separate network core operated in parallel with NOC 106) or may be part of a different communication network.

Returning to FIG. 1A, NOC 106 may include may comprise modules, also referred to as network functions (NFs), that include one or more of a core access and mobility management function (AMF) 108, an access network discovery and selection policy (ANDSP) 114, a user plane function (UPF) 116, a session management function (SMF) 120, a policy control function (PCF) 118, a network exposure function (NEF) 110, and an operations support system (OSS) 112. Implementation of these network functions may be executed by at least one controller 124 on which the network these one or more network functions are orchestrated or otherwise configured to execute utilizing processors and memory of the one or more controller 124. Moreover, the network function may be implemented as physical or virtual network functions.

The AMF 108 facilitates mobility management, registration management, and connection management for 3GPP devices such as a sensor device 104. ANDSP 114 facilitates mobility management, registration management, and connection management for non-3GPP devices. SMF 120 facilitates initial creation of protocol data unit (PDU) sessions using session establishment procedures. The PCF 118 maintains and applies policy control decisions and subscription information. Additionally, in some aspects, the PCF 118 maintains quality of service (QoS) policy rules. For example, the QoS rules stored in a unified data repository can identify a set of access permissions, resource allocations, or any other QoS policy established by an operator.

Some aspects of NOC 106 includes a unified data repository (UDR) 122 for storing information relating to access control. The UDR 122 is generally configured to store information relating to subscriber information and access and may be accessible by multiple different NFs in order to perform desirable functions. For example, the UDR 122 may be accessed by the AMF in order to determine subscriber information, accessed by a PCF 118 to obtain policy related data, accessed by a NEF 110 to obtain data that is permitted for exposure to third party applications. Such subscriber information may include whether a particular UPF 116 has access or is eligible to utilize witness data collection services of the wireless network provider.

In addition to being accessible by one or more NFs, such as those described herein, the one or more NFs may also write information to the UDR 122. Similar to the AMF 108, the network environment 100a depicts the UDR 122 according to a version of the 3GPP 5G architecture; in other network architectures, it is expressly conceived that the UDR 122 may take any desirable form of a data repository capable of being written to and accessed by one or more NFs or other functions or modules (e.g., a call session control function). Though not illustrated so as to focus on the novel aspects of the present disclosure, the network environment may comprise a unified data management module (UDM) which may facilitate communication between an NF, function, or module and the UDR 122. Although depicted as a unified data management module, UDR 122 can be a plurality of network function (NF) specific data management modules.

The UPF 116 is generally configured to facilitate user plane operation relating to packet routing and forwarding, interconnection to a data network, policy enforcement, and data buffering, among others. In aspects where one or more portions of the network environment 100a or base station 102a are not structured according to the 3GPP 5G architecture, the UPF 116 may take other forms, such as a serving/packet gateway (S/PGW).

Notably, the preceding nomenclature is used with respect to the 3GPP 5G architecture; in other aspects, each of the preceding functions and/or modules may take different forms, including consolidated or distributed forms that perform the same general operations. For example, the AMF 108 in the 3GPP 5G architecture is configured for various functions relating to security and access management and authorization, including registration management, connection management, paging, and mobility management; in other forms, such as a 4G architecture, the AMF 108 of FIG. 1A may take the form of a mobility management entity (MME). The NOC 106 may be generally said to authorize rights to and facilitate access to an application server/service such as network sever 126, requested by any sensor device 104.

Network sever 126 generally facilitates hosting services, data, or both for an application that distributes sensor data. For example, a remote service can be application server hosting an weather prediction services, surf prediction (e.g., tide, wind speed and direction, wave height), soil condition prediction, navigation services, traffic monitoring services, controlled access services, inventory management system, storage service, or any other similar service. The hosted website or data server can support any type of website or application, including those that facilitate logistics, predictive analytics, media upload, download, streaming, distribution, or storage. Network environment 100 may further facilitate providing remote service 146 access to power data collected by network operator core 108. For example, as depicted in FIG. 1A, remote service 146 may access power data stored in immutable power data archive 144. In some embodiments, access to power data is provided directly via permissioned access to a node of a DLN maintaining a copy of immutable power data archive 144. Additionally, or alternatively, remote service 146 may access sensor data via communication with network operator core 108.

Turning to FIG. 2 and with passing reference to FIGS. 1A and 1B, an illustrative example of a sensor device 200 is depicted in accordance with aspects described herein. Generally, sensor device 200 is configured to receive and broadcast RF signals for bidirectional communication between UE 200 and a base station. For example, sensor device 200 may be sensor device 104 in FIGS. 1A and 1B. Generally, sensor device 200 includes sensor 202, rectifier 204, antenna 206, power manager 208, and battery 210. In some embodiments, the sensor device 200 includes an operating system hosted by a remote data center. The remote data center may be incorporated in NOC (e.g., NOC 106), network server (e.g., network server 126 or another network server), or a combination thereof. For example, at least one embodiment of sensor device 200 does not include a locally installed operating system. Rather, the computational burden and power consumption associated with execution of an operating system is offloaded to a remote processor or set of processors communicatively coupled to the sensor device 200 via a base station (e.g., base station 102a). Advantageously, offloading the operating system of sensor device 200 may facilitate comparatively lower power consumption than a sensor device that includes a locally installed and executed operating system. Further, offloading the operating system of sensor device 200 may facilitate incorporation of comparatively lower localized processing capability than a sensor device that includes a locally installed and executed operating system.

The sensor 202 of sensor device 200 collects data that is transmitted to the NOC 106 or a network sever 126 via antenna 206 and a base station (e.g., base stations 100b or 102b). The sensor 202 may include one or more: accelerometer (i.e., a device that measures acceleration); altimeter (i.e., a device that measures altitude or height above sea level); ammeter (i.e., a device that measures electric current); anemometer (i.e., a device that measures wind speed and direction); barometer (i.e., a device that measures atmospheric pressure); hydrometer (i.e., a device that measures the specific gravity of liquids); hygrometer (i.e., a device that measures humidity or moisture content in the air); inclinometer (i.e., a device that measures the angle of slope or inclination); light sensor (i.e., a device that measures the intensity of light or the amount of light present), such as a charged-coupled device (CCD) or an active-pixel sensor (e.g., CMOS sensor); magnetometer (i.e., a device that measures magnetic fields); pH meter (i.e., a device that measures the acidity or alkalinity of a solution); proximity sensor (i.e., a device that detects the presence of nearby objects without physical contact); pyrometer (i.e., a device that measures high temperatures); refractometer (i.e., a device that measures the refractive index of a substance); seismometer (i.e., a device that measures ground motion caused by earthquakes or other vibrations); speedometer (i.e., a device that measures the speed of a moving object); tachometer (i.e., a device that measures the rotational speed of a motor or other mechanical device); thermocouple (i.e., a device that measures temperature using the voltage generated by the junction of two different metals); thermometer (i.e., a device that measures temperature using a variety of methods, including expansion of liquids, electrical resistance, or infrared radiation); tilt sensor (i.e., a device that measures the orientation of an object relative to gravity); ultrasonic sensor (i.e., a device that uses sound waves to measure distance); voltmeter (i.e., a device that measures electrical potential difference); weight sensor (i.e., a device that measures the weight or mass of an object); or any combination thereof. The sensors may be combined to collect aggregated data. For example, sensor 202 data to be aggregated to generate access control data, weather data, road condition data, air quality data, water quality data, object detection data, or any similar type of data.

The rectifier 204 converts the induced alternating current into a direct current. To facilitate the conversion, rectifier 204 may be coupled to antenna 206. The coupling can comprise any technique suitable to allow the induced current to flow as input to the rectifier 204. For example, the rectifier 204 may can be soldered, crimped, or otherwise coupled to the antenna 206. In some aspects, rectifier 204 may be indirectly coupled to antenna 206 via another component of sensor device 200. For example, the rectifier 204 may be coupled to antenna 206 via a radio. Generally, the rectifier may be single-phase or multi-phase depending on the network configuration. For example, in some embodiments the rectifier 204 is configured for half-wave rectification. In some embodiments the rectifier 202 is configured for full-wave rectification. The rectifier 204 may include input filters to smooth the output DC current. In some aspects, the rectifier 204 may be part of, or coupled to an ambient electromagnetic power harvesting (AEPH) chip that converts electromagnetic power to electrical current. Additionally, rectifier 204 may be coupled to power manager 208.

Antenna 206 may be one or more omnidirectional antennas or directional antennas. Similarly, antenna 206 may comprise monopole or dipole elements. In some embodiments, antenna 206 in intentionally optimized to receive and broadcast at a particular frequency or range of frequencies. For example, antenna 206 may be tuned to receive and broadcast in the range of 2.1 GHZ and 86 GHz.

Power manager 208 includes hardware and software that upon activation, power management control performs one or more operations. For example, the power manager 208 may analyze the captured RF signals using a software defined radio executed by power manager 208. The software defined radio may include one or more filters configured to isolate a range of radio frequencies. The filters may be configured with exclusionary logic, inclusionary logic, or both. In an embodiment, the filters are programed to exclude the range of radio frequencies corresponding to those currently facilitating bidirectional communication between a base station (e.g., base station 102a of FIGS. 1A and 1B) and sensor device 200. In an embodiment, the filters are programed to isolate a range of radio frequencies based on the power of the received RF signals. Said another way, the filters may identify a range of radio frequencies received by the sensor device 200 above a predetermined threshold. The filters may further exclude the radio frequencies currently being used by the sensor device 200 to communicate with a base station. The power manager 208 can activate rectifier 202 to harvest energy from at least one of the radio frequencies, or range of frequencies, isolated by the filters.

Additionally, power manager 208 may execute operations that cause the sensor device 200 to communicate a payload including power manager log data to a network core for storage. For example, the power manager 208 monitors and collects data related to the energy harvested by the sensor device 200 from RF signals. For example, the power manager 208 may collect data identifying the frequencies used by rectifier 204 to generate current, the amount of current generated, the voltage of the current generated, the amount of current transmitted to battery 210, used by sensor device 200, transmitted to a remote device, or any combination thereof. Additionally, power manager 208 includes executable code that calculates secondary data. For example, power manager 208 may calculate the power generated by rectifier 204, the efficiency of energy harvesting, the power transferred to a remote device, or any combination thereof. Power manager 208 may communicate this data to a NOC 106 or network sever 126.

Generally, battery 210 converts chemical energy into electrical energy to power, or at least partially power, UE 200. Battery 210 may be integrated with sensor device 200 or removable from sensor device 200 in some embodiments. As used in reference to the battery 210, a removable battery refers to a battery that, by design, can be connected with sensor device 200, disconnected, and replaced with another battery without compromising the integrity of the sensor device 200 other than removing a portion of the sensor device 200 housing intentionally designed to allow access to the battery. An integrated battery refers to a battery that, by design, is not removable. Battery 210 may include any suitable combination of chemicals in one or more cells. In some embodiments, battery 210 is rechargeable (e.g., the chemical process that produces the electrical energy is intentionally reversible). For example, battery 210 may be a Lead-acid, Zinc-air, Lithium polymer (Li—Po), Nickel-Cadmium (NiCad), Nickel-Metal Hydride (NiMH), Lithium Ion (Li-ion) battery, or any other suitable combination.

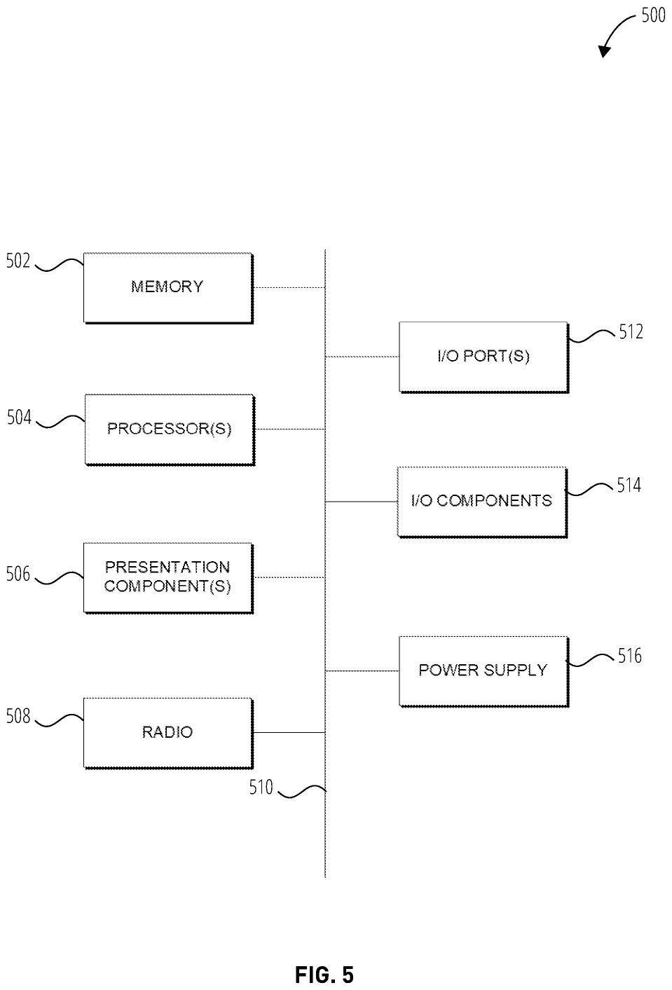

Additionally, some embodiments of sensor device 200 include an I/O port that facilitates coupling with a remote device. For example, output may be an input/output port (e.g., I/O port 512 of FIG. 5) or a similar to I/O port 512 in some aspects. The coupling may be facilitated by a wire-based connector. For example, the coupling may be facilitated by a universal serial bus (USB) type wire-based connector, a Thunderbolt®, or similar wire-based connector. Additionally, or alternatively, output may include a wireless coupling system. For example, the coupling may be facilitated by electromagnetic induction coil. Amongst other things, output is configured to transfer power from sensor device 200 to a remote device. The remote device may include additional sensors that are not otherwise integrated with sensor device 200.

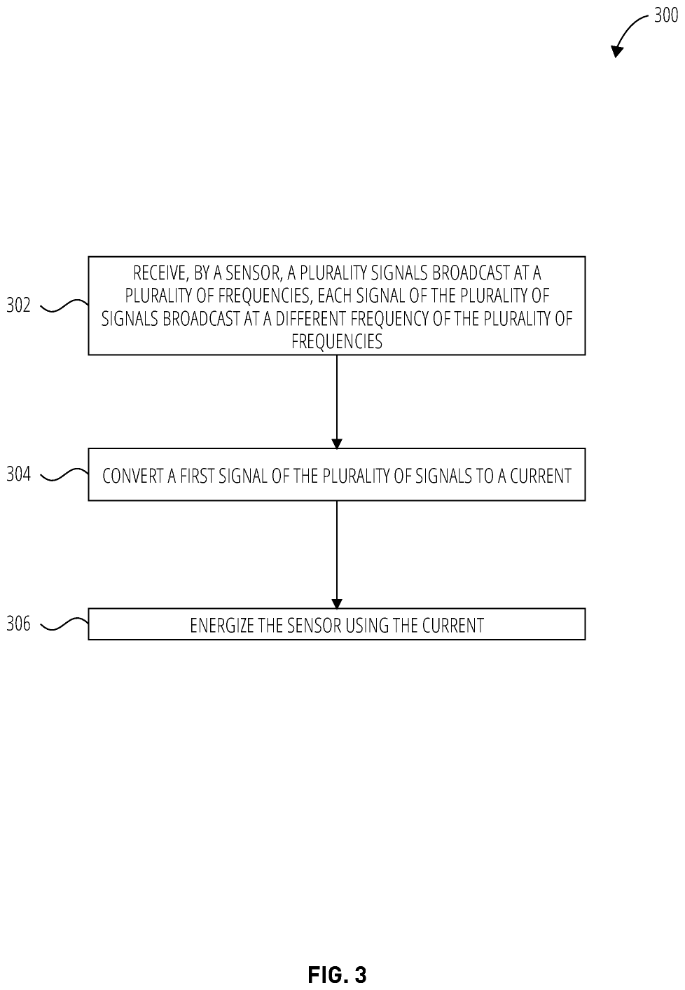

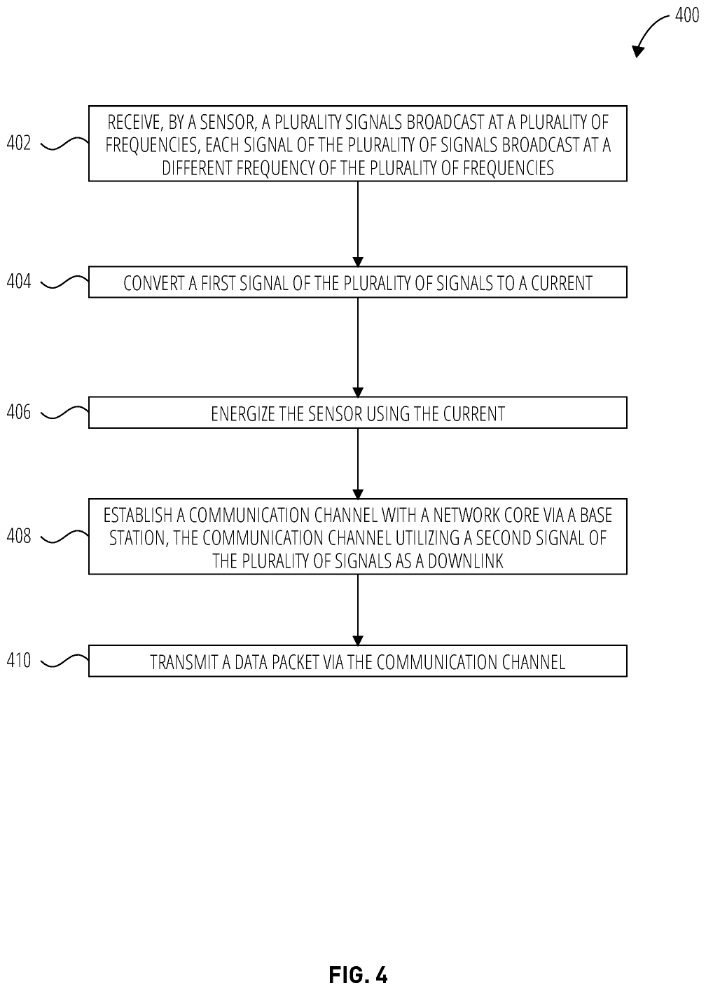

Turning to FIG. 3, a method 300 for remote power harvesting for a remote sensor device is depicted, in accordance to aspects described herein. Some embodiments of method 300 may be facilitated by a remote sensor device (e.g., sensor device 200 of FIG. 2 and sensor device 104 of FIGS. 1A and 1B) that is configured to absorb RF signals. Some embodiments of method 300 include additional steps not specifically depicted with FIG. 3. For example, method 300 may include one or more steps of method 400 described in relation to FIG. 4. Some embodiments of method 300 being with block 302.

In block 302, method 300 receives, by a sensor, a plurality signals broadcast at a plurality of frequencies, each signal of the plurality of signals broadcast at a different frequency of the plurality of frequencies. In some embodiments, a remote sensor receives the plurality of RF signals. In some embodiments, each signal of the plurality of signals is broadcast at a different frequency of the plurality of frequencies. For example, a base station (e.g., base station 102a of FIG. 1A or base station 102b of FIG. 1B) may broadcast RF signals with a plurality of frequencies. One or more of the RF signals may initiate, or be part of an existing, bidirectional communication channel between a remote sensor and a base station. The received plurality of frequencies are analyzed to identify one or more frequencies to convert to electrical current in some aspects of method 300. For example, a power manager 208 analyses the received RF signals and identifies one or more frequencies to convert to electrical current.

In block 304, method 300 converts a first signal of the plurality of signals to a current. Some embodiments of block 304 may be facilitated by one or more components of a sensor described in reference to FIGS. 1A, 1B, and 2. For example, the antenna 206 may absorb the RF signals broadcast by the base station. A software defined radio may pass RF signals of a frequency, set of frequencies, or range of frequencies to a rectifier (e.g., rectifier 204 of FIG. 2).

In block 306, method 300 energizes the sensor using the current. Some embodiments of method 300 includes transferring the current generated by a rectifier to a battery 210 for later consumption or sensor 202 for immediate use.

Turning to FIG. 4, another method 400 for remote power harvesting for a remote sensor device is depicted, in accordance to aspects described herein. Some embodiments of method 400 may be facilitated by a remote sensor device (e.g., sensor device 200 of FIG. 2 and sensor device 104 of FIGS. 1A and 1B) that is configured to absorb RF signals. Some embodiments of method 400 include additional steps not specifically depicted with FIG. 4. Some embodiments of method 400 being with block 402.

At block 402, method 400 receives, by a sensor, a plurality signals broadcast at a plurality of frequencies, each signal of the plurality of signals broadcast at a different frequency of the plurality of frequencies. In some embodiments, a remote sensor receives the plurality of RF signals. In some embodiments, each signal of the plurality of signals is broadcast at a different frequency of the plurality of frequencies. For example, a base station (e.g., base station 102a of FIG. 1A or base station 102b of FIG. 1B) may broadcast RF signals with a plurality of frequencies. One or more of the RF signals may initiate, or be part of an existing, bidirectional communication channel between a remote sensor and a base station. The received plurality of frequencies are analyzed to identify one or more frequencies to convert to electrical current in some aspects of method 400. For example, a power manager 208 analyses the received RF signals and identifies one or more frequencies to convert to electrical current.

In block 404, method 400 converts a first signal of the plurality of signals to a current. Some embodiments of block 404 may be facilitated by one or more components of a sensor described in reference to FIGS. 1A, 1B, and 2. For example, the antenna 206 may absorb the RF signals broadcast by the base station. A software defined radio may pass RF signals of a frequency, set of frequencies, or range of frequencies to a rectifier (e.g., rectifier 204 of FIG. 2).

In block 406, method 400 energizes the sensor using the current. Some embodiments of method 400 includes transferring the current generated by a rectifier to a battery 210 for later consumption or sensor 202 for immediate use.

In block 408, method 400 establishes a communication channel with a network core via a base station, the communication channel utilizing a second signal of the plurality of signals as a downlink. For example, a remote sensor can establish a bidirectional communication channel with NOC 106 via base station 102a.

In block 410, method 400 transmits a data packet via the communication channel. The transmission may include the local record of electrical current of block 404 or block 406 and additional data generated by sensor 202, in some embodiments. For example, a power manager 208 may encode a payload for transmission via the communication channel established in block 408. Additionally, the payload may include sensor device 200 data associated with the sensor 202. For example, the sensor data may include: accelerometer data; altimeter data; ammeter data; anemometer data; barometer data; hydrometer data; hygrometer data; inclinometer data; light sensor data (e.g., lumes, colors, or images); magnetometer data; pH meter data; proximity sensor data; pyrometer data; refractometer data; seismometer data; speedometer data; tachometer data; thermocouple data; thermometer data; tilt sensor data; ultrasonic sensor data; voltmeter data; weight sensor data; or any combination thereof. As can be appreciated in view of the description provided herein, supplementing the payload with additional sensor and power data can provide enhanced power harvesting tracking. For example, including the power data may facilitate more efficient RF resource consumption at a particular base station.

Turning to FIG. 5, computer device 500 includes bus 610 that directly or indirectly couples the following devices: memory 502, one or more processor 504, one or more presentation component 506, input/output (I/O) ports 512, I/O components 514, and power supply 516. Bus 510 represents what may be one or more busses (such as an address bus, data bus, or combination thereof). Although the devices of FIG. 5 are shown with lines for the sake of clarity, in reality, delineating various components is not so clear, and metaphorically, the lines would more accurately be grey and fuzzy. For example, one may consider a presentation component such as a display device to be one of I/O components 514. Also, processors, such as one or more processors 504, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

Computing device 500 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 502 includes computer-storage media in the form of volatile and/or nonvolatile memory. Memory 502 may be removable, nonremovable, or a combination thereof. Exemplary memory includes solid-state memory, hard drives, optical-disc drives, etc. Computer devices 500 includes one or more processor 504 that read data from various entities such as bus 510, memory 502 or I/O component 514. One or more presentation component 506 presents data indications to a person or other device. Exemplary one or more presentation components 506 include a display device, speaker, printing component, vibrating component, etc. I/O ports 512 allow computer device 500 to be logically coupled to other devices including I/O component 514, some of which may be built in computer device 500. Illustrative I/O component 514 include a microphone, camera, joystick, game pad, satellite dish, scanner, printer, wireless device, etc.

Radio 508 represents a radio that facilitates communication with a wireless telecommunications network. In aspects, the radio 624 utilizes one or more transmitters, receivers, and antennas to communicate with the wireless telecommunications network on a first downlink/uplink channel. Though only one radio is depicted in FIG. 5, it is expressly conceived that the computer device 500 may have more than one radio, and/or more than one transmitter, receiver, and antenna for the purposes of communicating with the wireless telecommunications network on multiple discrete downlink/uplink channels, at one or more wireless nodes. Illustrative wireless telecommunications technologies include CDMA, GPRS, TDMA, GSM, and the like. Radio 508 might additionally or alternatively facilitate other types of wireless communications including Wi-Fi, WiMAX, LTE, or other VoIP communications. As can be appreciated, in various embodiments, radio 508 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

Network environment 100 can include remote service 146. Remote service 146 generally facilitates hosting services, data, or both for an application monitoring power data. For example, a remote service can be application server hosting an inventory management system, outfacing services (e.g., banking, medical, social, and similar services), or storage service. The hosted website or data server can support any type of website or application, including those that facilitate logistics, gaming, media upload, download, streaming, distribution, or storage. Network environment 100 may further facilitate providing remote service 146 access to power data collected by network operator core 108. For example, as depicted in FIG. 1A, remote service 146 may access power data stored in immutable power data archive 144. In some embodiments, access to power data is provided directly via permissioned access to a node of a DLN maintaining a copy of immutable power data archive 144. Additionally, or alternatively, remote service 146 may access sensor data via communication with network operator core 108.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The subject matter of the technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of the methods employed, the terms should not be interpreted as implying any particular order among or between various steps herein disclosed unless and except when the order of individual steps is explicitly described.

Throughout the description provided herein several acronyms and shorthand notations are used to aid the understanding of certain concepts pertaining to the associated system and services. These acronyms and shorthand notations are intended to help provide an easy methodology of communicating the ideas expressed herein and are not meant to limit the scope of embodiments described in the present disclosure. Unless otherwise indicated, acronyms are used in their common sense in the telecommunication arts as one skilled in the art would readily comprehend. Further, various technical terms are used throughout this description. An illustrative resource that fleshes out various aspects of these terms can be found in Newton's Telecom Dictionary, 31st Edition (2018).

As used herein, the terms “function”, “unit”, “node” and “module” are used to describe a computer processing components and/or one or more computer executable services being executed on one or more computer processing components. In the context of this disclosure, such terms used in this manner would be understood by one skilled in the art to refer to specific network elements and not used as nonce word or intended to invoke 35 U.S.C. 114 (f).

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method comprising:
receiving, by a sensor, a plurality signals broadcast at a plurality of frequencies, each signal of the plurality of signals broadcast at a different frequency of the plurality of frequencies;
converting a first signal of the plurality of signals to a current; and
energizing the Sensor using the current.

2. The method of claim 1, wherein the plurality of frequencies are in the range of 2.1 GHz and 86 GHz.

3. The method of claim 1, wherein the first signal is in the range of 2.4 GHz and 2.6 GHz.

4. The method of claim 1, further comprising establishing a communication channel with a network core via a base station, the communication channel utilizing a second signal of the plurality of signals as a downlink.

5. The method of claim 4, further comprising transmitting a data packet via the communication channel.

6. The method of claim 5, wherein the data packet comprises a quantification of the current transmitted to the remote device as a measure of power.

7. The method of claim 5, wherein the data packet comprises at least one of temperature data, precipitation data, wind speed data, wind direction data, or atmospheric pressure data.

8. The method of claim 1, further comprising charging a battery electrically coupled to the remote Sensor.

9. A system comprising:
a remote sensor including at least one Antenna communicatively coupled to a rectifier circuit;
computer readable memory storing instructions that when executed by the remote Sensor cause the remote sensor device to perform operations including:
receiving, via the at least one antenna, a plurality signals broadcast at a plurality of frequencies, each signal of the plurality of signals broadcast at a different frequency of the plurality of frequencies;
converting, via the rectifier, a first signal of the plurality of signals to a current; and
energizing transmitting the current to a remote device.

10. The system of claim 9, wherein the plurality of frequencies are in the range of 2.1 GHz and 86 GHz.

11. The system of claim 9, wherein the first signal is in the range of 2.4 GHz and 2.6 GHz.

12. The system of claim 9, wherein the operations further include establishing a communication channel with a network core via a base station, the communication channel utilizing a second signal of the plurality of signals as a downlink.

13. The system of claim 9, wherein the operations further include establishing a communication channel with a network core via a base station, the communication channel utilizing a second signal of the plurality of signals as a downlink.

14. The system of claim 13, wherein the operations further include transmitting a data packet via the communication channel.

15. The system of claim 14, wherein the data packet comprises at least one of temperature data, precipitation data, wind speed data, wind direction data, or atmospheric pressure data.

16. The system of claim 9, wherein the system further comprises a battery electrically coupled to the remote Sensor.

17. The system of claim 16, further comprising charging the battery.

18. A non-transitory computer-readable storage medium, the computer-readable storage medium including instructions that when executed by a computer, cause the computer to:
receive, by a Sensor, a plurality signals broadcast at a plurality of frequencies, each signal of the plurality of signals broadcast at a different frequency of the plurality of frequencies;
convert a first signal of the plurality of signals to a current; and
energize the Sensor using the current.

19. The computer-readable storage medium of claim 18, wherein the instructions further configure the computer to charge a battery electrically coupled to the remote Sensor.

20. The computer-readable storage medium of claim 18, wherein the plurality of frequencies are in the range of 2.1 GHZ and 86 GHz.
